(19) United States
(12) Patent Application Publication
(10) Pub. No.: US 2026/0261231 A1
(43) Pub. Date: Sep. 3, 2026

(54) SYSTEM AND METHOD FOR PRODUCING ELECTRICITY WITH SOLAR PANELS

(71) Applicant: Trailander Oy, SEINÄJOKI (FI)

(72) Inventor: Veikko Rintamäki, SEINÄJOKI (FI)

(73) Assignee: Trailander Oy, SEINÄJOKI (FI)

(21) Appl. No.: 18/872,872

(22) PCT Filed: Jun. 30, 2023
(86) PCT No.: PCT/FI2023/050420

§ 371 Date: Dec. 9, 2024

(30) Foreign Application Priority Data
Jul. 6, 2022 (FI) 20225633

(51) Int. Cl. H02S 20/32; G05D 3/10

(52) U.S. Cl. CPC H02S 20/32; G05D 3/105

(57) ABSTRACT

A system for producing electricity with solar panels includes solar panel systems arranged in a grid formation, wherein each solar panel system includes a solar cell assembly consisting of solar panels configured to be movable on a support structure. A connection of each solar cell assembly includes rotation means and tilting means. The system includes control means by means of which, at a selected moment in time, when an incoming angle of the sun's rays is greater than a selected minimum value, but less than a selected limit value, the solar cell assemblies are configured to be
rotated so that an angle of rotation of the solar cell assemblies relative to the direction of incoming sunlight is 20°-50°, and
tilted to reduce a three-dimensional solar incidence angle of the solar cell assemblies so that the solar cell assemblies do not overshadow one another.

The invention relates to a system for producing electricity with solar panels north of the latitude 55°N or south of the latitude 55° S, which system comprises a plurality of individual solar panel systems arranged in a grid formation so as to form a solar panel field, wherein each individual solar panel system comprises a solar cell assembly made up of solar panels that is configured to be movable on a support structure with respect to two axes, so that a connection of each individual solar cell assembly to the support structure comprises rotation means for rotating the solar cell assembly relative to a vertical axis of the support structure and tilting means for tilting the solar cell assembly relative to a horizontal plane, and wherein, when an incoming angle of the sun's rays in the grid formation is less than 20° and when the solar cell assemblies are perpendicular to the sun, the solar cell assemblies overshadow one another, wherein in the system a width of the solar cell assembly of each solar panel system is 3-6 times, preferably 3.5-5 times, a height of the solar cell assembly. The invention also relates to a corresponding method.

Solar panel fields or solar parks are used for the production of electricity in particular in sunny countries and near the equator, where the sun shines high in the sky for most of the day and year. It is known that an individual solar panel can be rotated during the day with a selected accuracy in order to track the movements of the sun, so that the solar panel can be kept perpendicular to the sun as the sun moves, so as to be able to maximize an output of the individual solar panel. Typically, an angle of deviation of a position of the solar panel from the perpendicular with respect to the sun is kept below one degree.

The solar panel can be moved relative to its support structure about one or two axes. With a single axis of rotation, it is possible to track either the elevation or the azimuthal direction of the sun. Dual-axial solutions typically involve a tilting of the solar panel in two directions or a rotation of the solar panel and a tilting of the same in a single direction with respect to the support structure. By means of the two axes of rotation, the solar panels are typically kept perpendicular to the sun at all times.

A problem with the use of solar panel fields at very northern or very southern latitudes is the low incoming angle of the sun's rays. Solar panel fields used near the equator are not suitable for use further away from the equator or in the morning and evening sun, because the individual solar panels overshadow one another due to the low incoming angle of the sunrays. If a part of the cells of a solar panel is overshadowed, the entire solar panel does not produce any electricity. Typically, a plurality of solar panels are connected in series to the same inverter so that, if one panel is even partially shaded, the aggregate of these solar panels connected in series will not produce any electricity. An inter-shading of individual solar panels can thus cause a collapse in the electricity production of an entire solar field.

So-called half-cut solar panels are known, in which the solar cell assembly is divided into two parts. In this case, an individual solar panel has a large number of solar cells connected in such a manner that, even if a part of the solar panel is shaded, the solar panel still produces electricity. Typically, a half-cut solar panel is divided into two equal parts by surface area, which operate independently.

A land area on which a solar panel field is arranged always represents a cost, so that it is desirable to exploit a limited surface area for the generation of solar power as efficiently as possible. It has not been possible with solar panel fields according to the prior art, however, especially at very northern and southern latitudes, to maximize the potential of the land surface area for electricity production.

In a compact solar panel field, situations inevitably arise in which solar panels overshadow one another if they are pointed directly at the sun. In the solutions according to the prior art, this situation is remedied by tilting the solar panels until there is no shading. It becomes necessary in this case, however, to turn the surface of the solar panel to a disadvantageously large three-dimensional solar incidence angle with respect to the sunlight, which reduces an output coefficient of the solar panel.

The sun exhibits a large observable rotational angle at high latitudes and shines very low in extreme regions. This is even more pronounced at very high latitudes, where in midsummer the sun does not set behind the horizon at all. As a result, north of the latitude 55°N and south of the latitude 55°S, both fixed solar panel fields and solar trackers according to the prior art encounter significant problems and significant amounts of available solar radiation energy are lost. In addition, according to statistics, relatively higher prices are quoted on the power market for energy of the early morning and late after-noon/evening. A problem with solar panel fields according to the prior art is thus that they mainly only produce electricity efficiently at midday and in midsummer, when electricity prices are statistically low.

An object of the invention is to provide an improved system for producing electricity with solar panels, by means of which system electricity production can be increased in a limited land area far from the equator. The characteristic features of this invention are set out in the attached patent claim 1. A further object of invention is to provide an improved method for producing electricity with solar panels, by means of which method electricity production can be increased in a limited land area far from the equator. The characteristic features of this invention are set out in the attached patent claim 10.

A system according to the invention for producing electricity with solar panels north of the latitude 55°N or south of the latitude 55° S, which system comprises a plurality of individual solar panel systems arranged in a grid formation so as to form a solar panel field, wherein each individual solar panel system comprises a solar cell assembly made up of solar panels that is configured to be movable on a support structure with respect to two axes, so that a connection of each individual solar cell assembly to the support structure comprises rotation means for rotating the solar cell assembly relative to a vertical axis of the support structure and tilting means for tilting the solar cell assembly relative to a horizontal plane, and wherein, when an incoming angle of the sun's rays in the grid formation is less than 20° and when the solar cell assemblies are perpendicular to the sun, the solar cell assemblies overshadow one another, wherein a width of the solar cell assembly of each solar panel system is 3-6 times, preferably 3.5-5 times, a height of the solar cell assembly. The system comprises control means by means of which, at a selected moment in time, when an incoming angle of the sun's rays is greater than a selected minimum value, preferably greater than 1°, but less than a selected limit value, preferably less than 20°, more preferably less than 10°, most preferably less than 5°, the solar cell assemblies are configured to be rotated by the rotation means so that an angle of rotation of the solar cell assemblies relative to the direction of incoming sunlight is 20°-50°, preferably 30°-45°, and to be tilted by the tilting means in order to reduce a three-dimensional solar incidence angle of the solar cell assemblies in such a manner that the solar cell assemblies do not overshadow one another, by means of which rotation and tilting of the solar cell assemblies an inter-shading that would otherwise occur is prevented and an electricity output is maximized.

The system according to the invention thus otherwise corresponds to a stationary solar panel field, but a front orientation of the solar panel rows and an inclination of the solar panels can be changed by a desired graduation in a desired direction. An inter-shading of solar cell assemblies can thereby be significantly reduced. The solar panels thereby produce electricity efficiently even at low incoming angles of sunlight, so that electricity production can be maximized during the day in a limited land area.

In the system according to the invention, the three-dimensional solar incidence angle of the solar cell assemblies is thus ideally minimized also by deviation of the angle of rotation. It has been observed that, counter-intuitively and in contrast to the prior art, when the angle of rotation is turned significantly away from the perpendicular to the sun at a selected moment in time, the three-dimensional solar incidence angle can also be reduced to a greater extent than by simply tilting the solar cell assemblies, which yields an improvement in the overall electrical output of the system.

Preferably, a distance between the support structures of the solar panel systems in the grid formation is 1.05-1.3 times the width of the solar cell assembly of an individual solar panel system. This way, by placing the solar panel systems very close together, a maximum surface area of the land area can be exploited for the production of electricity with the solar panels.

A combined surface area of all solar panels in the solar panel field, more precisely the active, electricity-producing surface area of the solar panels, can be 10-40%, preferably 15-35%, most preferably 20-30%, of the total land surface area of the solar panel field. A limited land area can thereby be utilized efficiently for electricity production.

Preferably, the tilting means is configured to tilt the solar cell assembly in its end position into an essentially vertical and into an essentially horizontal position. In the vertical position, snow and other debris that has accumulated on the solar cell assemblies can be removed solely by the force of gravity or can be easily cleaned off the surfaces of the solar cell assemblies. In the horizontal position, a lateral surface area of the solar panel system can be minimized, so that it is possible to protect the solar panel systems from a load caused by high winds.

Preferably, a frame of each solar panel system comprises, at a point of articulation, an outwardly projecting support element on the rear side of the solar cell assembly, wherein a first end of the support element is attached to the solar cell assembly and a second end of the support element comprises support means configured to be supported against the support structure when the solar cell assembly is in a horizontal position. The mechanical structure of the solar panel system can thereby be supported in order to protect it from strong winds.

Preferably, a height of the support structure is 1.7-3.0 m, so that a maintenance space is provided under each solar cell assembly. Any vegetation under the solar cell assemblies can thereby be kept short, for example by cutting the vegetation with machinery, such as a lawnmower, or by grazing sheep on the land area with solar panel systems, so that the vegetation does not overshadow the solar cell assemblies. During maintenance, the solar cell assemblies can be advantageously rotated into a horizontal position so as to increase the space underneath the solar cell assemblies. In regions that get a lot of snow, the height of the support structure can be dimensioned, for example, in such a manner that, when the solar cell assemblies are in a vertical position, a height of the lower edge of the solar cell assemblies from the ground must be at least the thickness of the snow cover plus the amount of snow accumulating on top of the solar cell assemblies.

Preferably, the solar cell assembly of each solar panel system is provided in the form of in two or more parts that operate independently, wherein a first part is located in an upper part of the solar cell assembly and a second part or the following parts are located underneath the first part in a lower part of the solar cell assembly. In other words, so-called half-cut solar panels are preferably used, although it is also possible for the first part and the second part to have surface areas of different sizes or for there to be multiple independently operating parts. An upper portion can produce electricity even if the field should be adjusted so as to allow a lower portion to be shaded. By exploiting this feature, the possibilities for minimizing shading can be further augmented in borderline cases in the system according to the invention.

Preferably, the height of the solar cell assembly of each solar panel system is 1.3-3 m, preferably 1.8-2.5 m. It is thus possible to manufacture the solar panel system at a relatively low cost vis-à-vis its productive output in electricity.

Preferably, the width of the solar cell assembly of each solar panel system is 5-10 m, preferably 7-9 m. It is thus possible to manufacture the solar panel system at a relatively low cost vis-à-vis its productive output in electricity.

Preferably, the system comprises software means for moving the solar cell assembly of each solar panel system via the control means. The software means can be configured to carry out a scan once or multiple times a day, wherein the scan preferably involves rotating and tilting a small part of the whole solar field, i.e. the solar cell assemblies of a few solar panel systems, by a selected magnitude of movement in order to find an optimal position for a power generation that is as efficient as possible. In other words, the angle of rotation and the angle of inclination at which the solar panel field produces the most electricity at that moment in time are sought.

In a method according to the invention for producing electricity with solar panels north of the latitude 55°N or south of the latitude 55°S, a plurality of solar panel systems are placed in a grid formation so as to form a solar panel field, wherein each individual solar panel system comprises a solar cell assembly made up of solar panels arranged on a support structure, with respect to which support structure the solar cell assembly is moved during the day with respect to two axes in such a manner that the solar cell assembly is rotated relative to a vertical axis of the support structure and tilted relative to a horizontal plane, and wherein, when an incoming angle of the sun's rays in the grid formation is less than 20° and when the solar cell assemblies are perpendicular to the sun, the solar cell assemblies overshadow one another, and wherein in the method a width of the solar cell assembly of each solar panel system is 3-6 times, preferably 3.5-5 times, a height of the solar cell assembly. At a selected moment in time, when an incoming angle of the sun's rays is greater than a selected minimum value, preferably greater than 1°, but less than a selected limit value, preferably less than 20°, more preferably less than 10°, most preferably less than 5°, the solar cell assemblies are rotated so that an angle of rotation of the solar assemblies relative to the direction of incoming sunlight is 20°-50°, preferably 30°-45°, and the solar cell assemblies are tilted in order to reduce a three-dimensional solar incidence angle of the solar cell assemblies in such a manner that the solar assemblies do not overshadow one another, by means of which rotation and tilting of the solar assemblies an intershading that would otherwise occur is prevented and an electricity output is maximized.

An inter-shading of solar cell assemblies can thereby be significantly reduced. The solar panels thus produce electricity efficiently even at low angles of incoming sunlight, so that electricity production can be maximized in a limited land area during the day all year round.

In the method according to the invention, the three-dimensional solar incidence angle of the solar cell assemblies is thus ideally minimized also by deviation of the angle of rotation. It has been observed that, counter-intuitively, when the angle of rotation is turned significantly away from the perpendicular to the sun at a selected moment in time, the three-dimensional solar incidence angle can also be reduced to a greater extent than by simply tilting the solar cell assemblies, whereby the method according to the invention yields an improvement in the overall electrical output of the solar panel field.

In the methods according to the prior art, the solar panels typically track the sun at an orthogonal angle with a selected accuracy. The solar panels thus overshadow one another at a low incoming angle of sunlight, which causes the output of the field to collapse. Surprisingly, it has been found that, by actively positioning the solar panels to deviate significantly from a perpendicular position at a selected moment in time, the total amount of electricity produced during the day can be significantly increased since, by means of this significant deviation from a perpendicular position, an inter-shading of the solar panels can be significantly reduced.

The three-dimensional solar incidence angle of the solar cell assemblies can be minimized with an accuracy of +/−5%, preferably +/−2%. The effective distance between successive solar panel systems of the solar panel field can be increased at a selected moment in time by rotating the solar panel systems, which can eliminate instances of inter-shading affecting the ends of the solar cell assemblies when necessary, upon which the solar cell assemblies can be tilted into a more upright position compared to a scenario in which the solar cell assemblies are oriented so as to be perpendicular to the sun, whereby the inclination of the solar cell assemblies can be optimized with a selected accuracy in order to minimize the three-dimensional angle of incidence.

Preferably, the solar panel systems are placed in the grid formation in such a manner that a distance between the support structures is 1.05-1.3 times the width of the solar cell assembly of an individual solar panel system. This way, by placing the solar panel systems very close together, a maximum surface area of the land area can be exploited for the production of electricity with the solar panels.

The solar panel systems can be placed in a dense grid in such a manner that a combined surface area of all solar panels of the solar panel field is 10-40%, preferably 15-35%, most preferably 20-30%, of the total land surface area of the solar panel field. A limited land area can thereby be utilized efficiently for electricity production.

Preferably, at a selected moment in time, when the incoming angle of the sun's rays is less than 20°, preferably less than 10°, most preferably less than 5°, the solar cell assemblies are tilted according to a selected criterion, preferably to an angle of inclination that is as perpendicular as possible in relation to the sun, so that each solar cell assembly produces electricity. This can mean that each solar cell assembly is positioned so as to be entirely in the sunlight or, in cases where the solar cell assembly is divided into independent parts, so that at least one part of the solar cell assembly is positioned in the sunlight. The electricity output of the solar panel field can thus be maintained at a very low angle of incoming sunlight.

It is also possible in the method according to the invention to first set the inclination of the solar cell assemblies so that the solar cell assemblies are as perpendicular as possible to the sun without, however, shading the other solar cell assemblies. A rotation of the solar cell assemblies is then set so that the solar cell assemblies do not shade one another and the total angle of incidence is minimized.

Preferably, the solar cell assembly of each solar panel system is provided in the form of two or more independently operating parts, a first part being arranged in an upper part of the solar cell assembly and a second part or the following parts being arranged underneath the first part in a lower part of the solar cell assembly, and at a selected point in time the solar cell assemblies are tilted so as to be as perpendicular as possible to the sun so that the first part or the uppermost parts of each solar cell assembly are in the sun and the second part or the lowermost parts are allowed to be shaded if necessary. The overall output of the solar panel field can thereby be maintained at a very low incoming angle of sunlight.

Preferably, the position of the solar cell assemblies is changed 2-7 times, preferably 3-6 times, diurnally. In the sun-tracking methods according to the prior art, the solar panels are moved tens or even hundreds of times a day so as to keep a deviation of the solar panels from a perpendicular position in relation to the incoming angle of the sun's rays very small. By significantly reducing the number of position changes, it is, however, possible to save on maintenance costs for the motors of the rotation means and tilting means moving the solar panels. The rotation of the front orientation of a large solar panel field also consumes a considerable amount of energy, which reduces the amount of electricity produced, so that it is possible to increase the total electricity output of the field by minimizing the number of daily position changes. The angle of incidence can still be maintained at an angle such that the output of the solar panels according to an IAM curve describing the performance of the solar panel remains good.

Preferably, at a selected moment in time, when the incoming angle of the sun's rays is greater than 20°, the solar cell assemblies are oriented so as to be perpendicular to the sun. At midday, even far from the equator, the incoming angle of the sun's rays can be so great that an inter-shading of the solar cell assemblies does not pose a problem, so that the solar cell assemblies can be oriented perpendicular to the sun in order to maximize the electricity output.

Preferably, a small part of the whole solar panel field, i.e. a few solar panel systems, is employed once or multiple times a day for a scan, wherein the solar cell assemblies are rotated and tilted by a selected magnitude of movement in order to find an optimal position for a power generation that is as efficient as possible. All solar panel systems of the solar panel field are then moved into the same position. An electricity output of the whole solar panel field can be maximized at a given moment this way. Using only a small part of the whole solar panel field for scanning saves energy and extends the lifetime of hardware.

In cloudy and stormy weather, the solar cell assemblies can be placed in a horizontal position, which can deviate significantly from the direction of the sun. In this case, the solar panels can produce more electricity from the effect of scattered radiation than if the solar panels were oriented towards the sun. In a horizontal position, the lateral surface area of the solar panel systems is also minimized, which makes it possible to minimize a load caused by wind in stormy weather.

Preferably, at a selected moment in time, when the incoming angle of the sun's rays (α) is 1°−20°, preferably 1°−10°, most preferably 1°−5°

$${D}^{′} min = f ( H , α , β , γ ) ,$$

D′min is the theoretical minimum distance of the support structures from one another in the grid formation,
H is the height of the solar cell assembly,
α is the minimum permitted incoming angle of the sun's rays,
β is the maximum permitted deflection of a sunbeam on the surface of a panel (3D geometry), and
γ is the selected directional deviation from the grid orientation (north-south), (date).

D′min can be calculated with these variables using basic trigonometry formulas.

If the grid is not in a north-south orientation, the directional deviation is smaller, but the formula holds. In this case, the operation does not exhibit a morning-evening symmetry, i.e. the same optimal situation is not achieved in the morning and in the evening.

The actual distance between support structures is determined by

$$Dact = ( 1.0 - 1.3 ) ⋆ {D}^{′} min + selected tolerance ,$$

where the selected tolerance is the minimum distance between the edges of the solar panel systems (usually 0.2-1 m).

The invention is illustrated in the following in detail with reference to the attached drawings illustrating embodiments of the invention, wherein

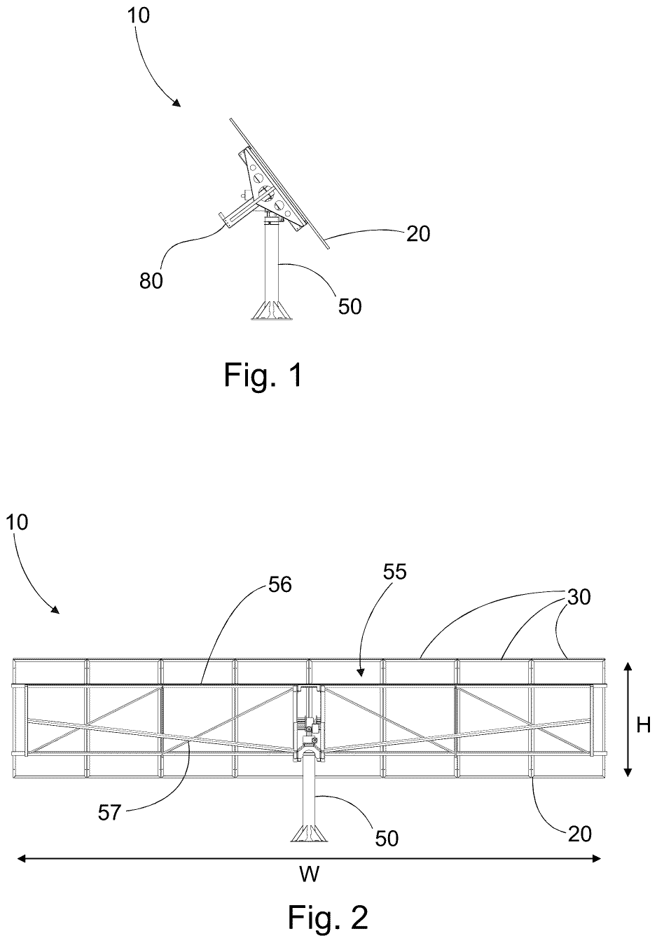

FIG. 1 illustrates a side view of an individual solar panel system according to the invention,

FIG. 2 illustrates a rear view of an individual solar panel system according to the invention,

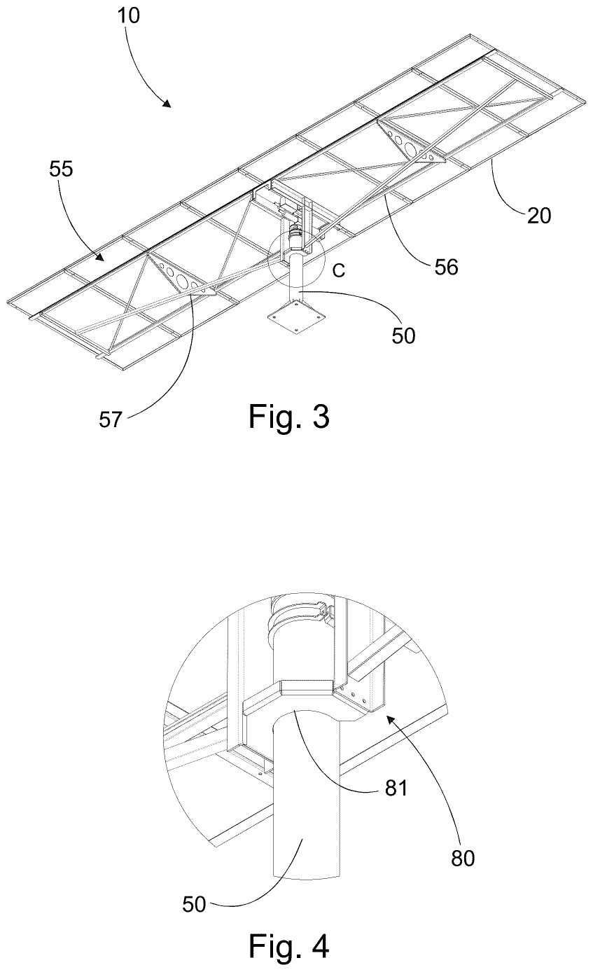

FIG. 3 illustrates a bottom perspective view of an individual solar panel system according to the invention,

FIG. 4 illustrates the supporting of a support element of an individual solar panel system according to the invention against a support structure,

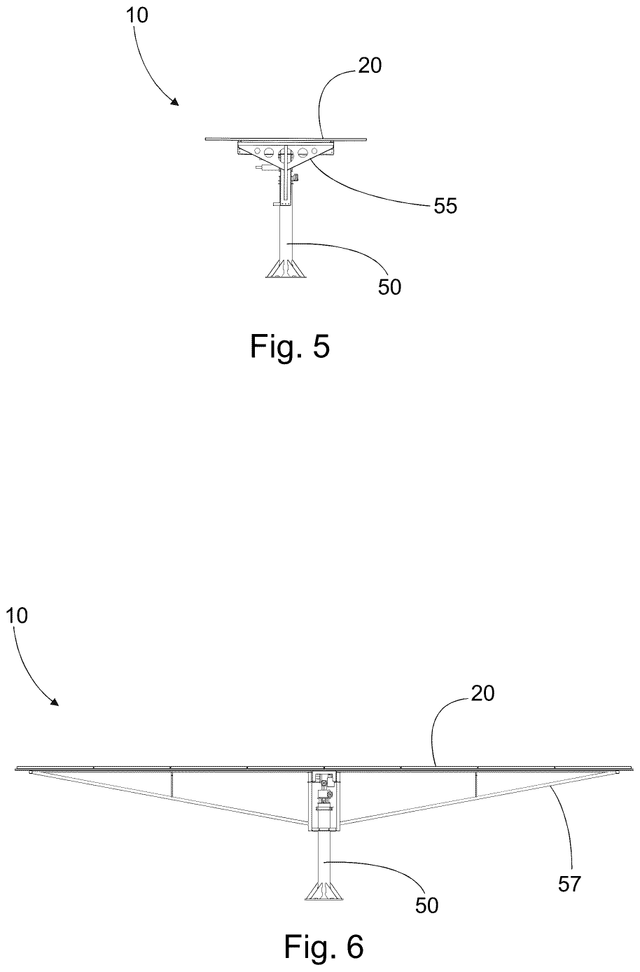

FIG. 5 illustrates a side view of an individual solar panel system according to the invention tilted to form a horizontal plane,

FIG. 6 illustrates a rear view of an individual solar panel system according to the invention tilted to form a horizontal plane,

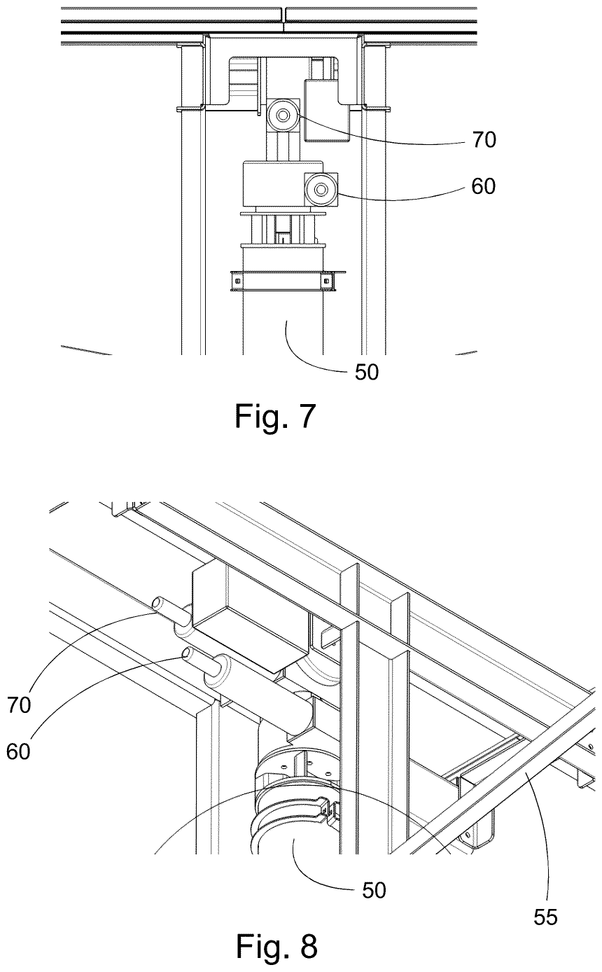

FIG. 7 illustrates a side view of a rotation means and a tilting means of an individual solar panel system according to the invention,

FIG. 8 illustrates a bottom perspective view of a rotation means and a tilting means of an individual solar panel system according to the invention,

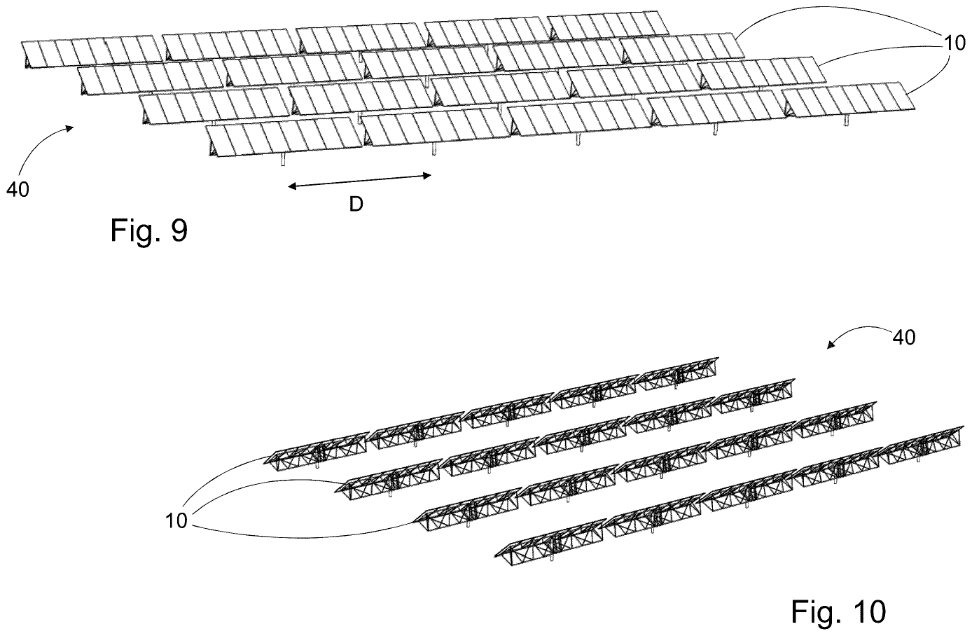

FIG. 9 illustrates a front perspective view of a solar panel field according to the invention,

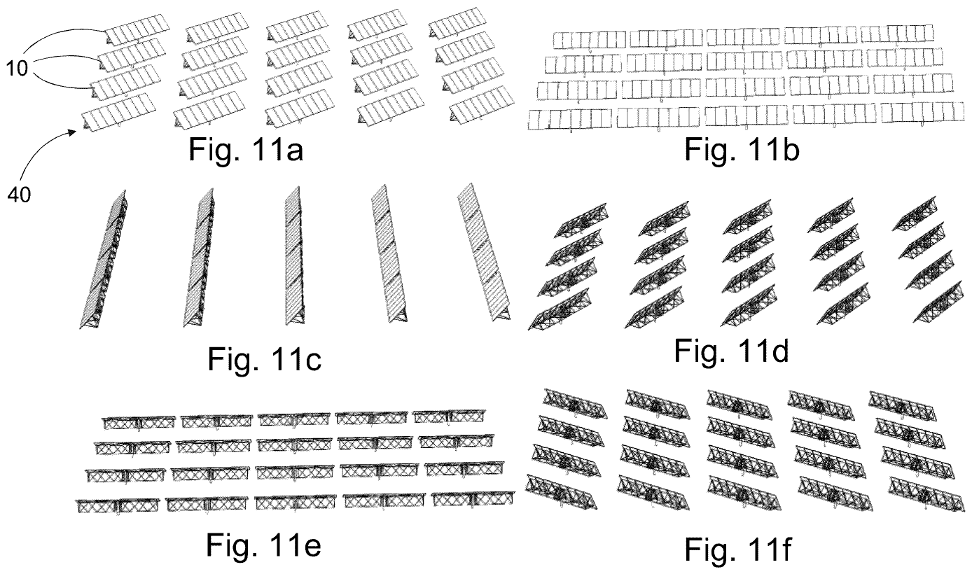

FIG. 10 illustrates a rear perspective view of a solar panel field according to the invention,

FIGS. 11a-11f present a series of illustrations of a solar panel field according to the invention, in which the position of the solar panel systems is changed during the day,

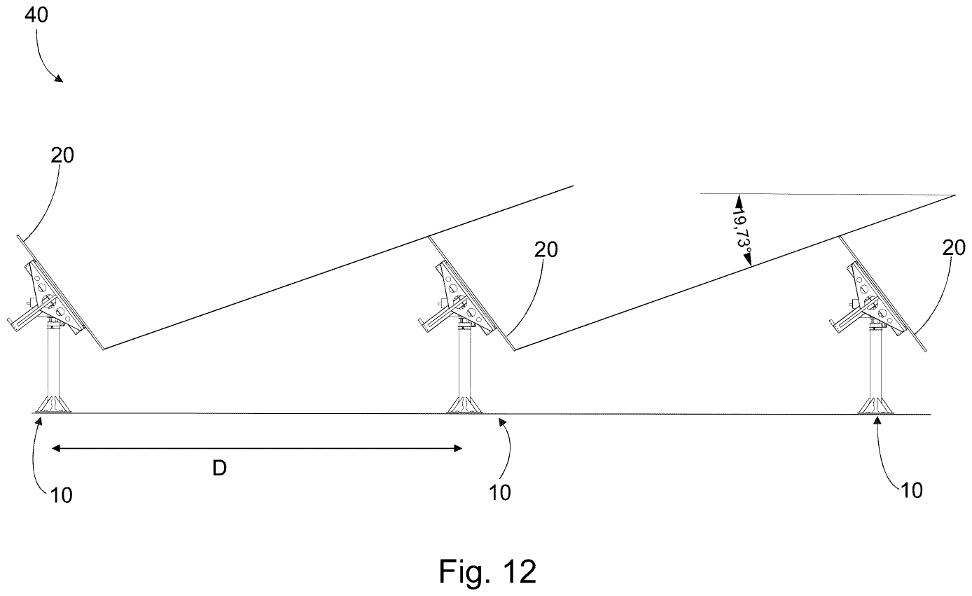

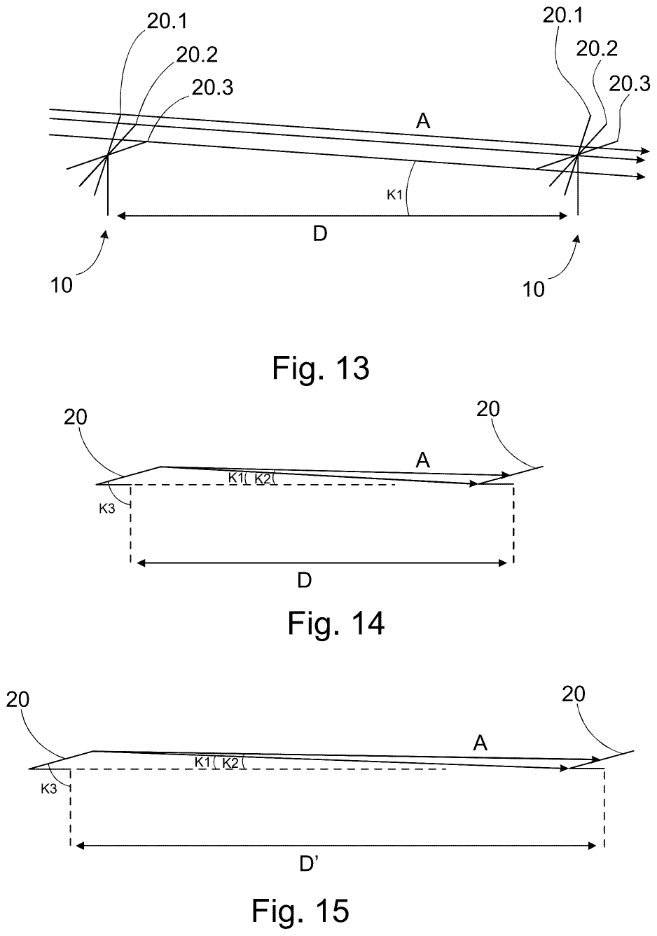

FIG. 12 illustrates a positioning of solar panel systems according to the invention according to an incoming angle of the sun's rays, schematically illustrates the effect of the an—FIG. 13 gle of inclination of a solar cell assembly on an inter-shading of solar panel systems,

FIG. 14 schematically illustrates the effect of the angle of rotation of a solar cell assembly on an inter-shading of solar panel systems when the angle of rotation is perpendicular to the sun,

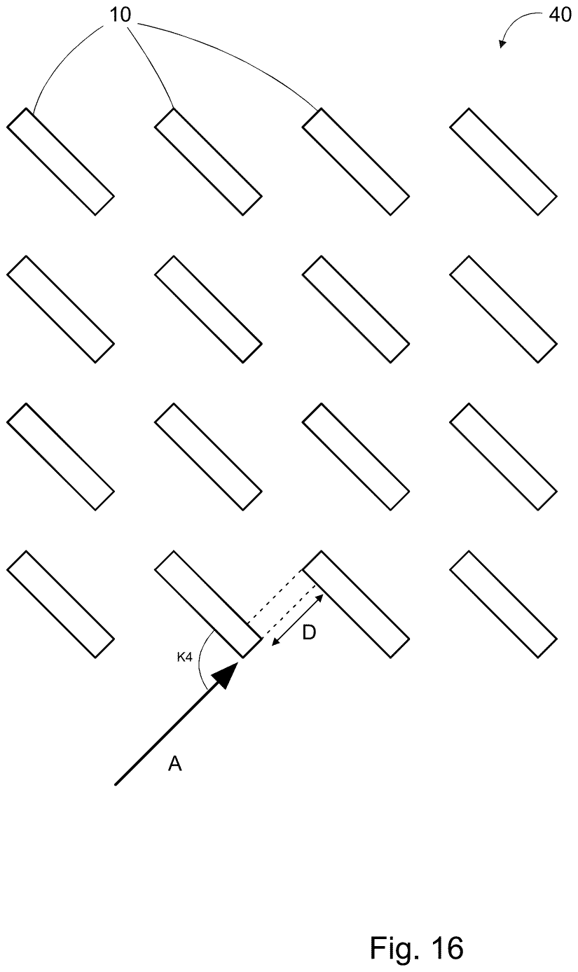

FIG. 15 schematically illustrates the effect of the angle of rotation of a solar cell assembly on an inter-shading of solar panel systems when the angle of rotation deviates by 45° from the incoming angle of the sun's rays,

FIG. 16 schematically illustrates solar cell assemblies of a solar panel field that are rotated so as to be perpendicular to the sunlight,

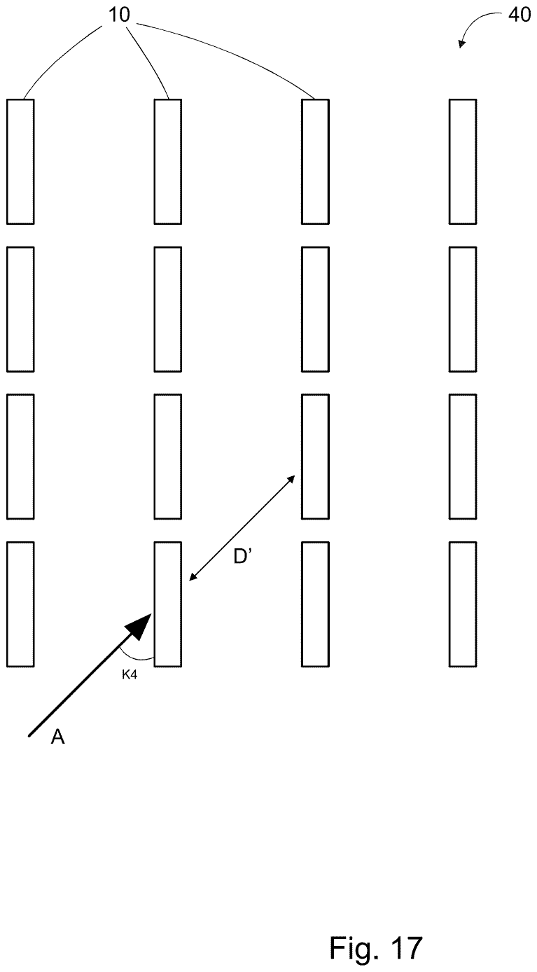

FIG. 17 schematically illustrates solar cell assemblies of a solar panel field that are rotated so as to be at a 45° angle relative to the incoming angle of the sun's rays.

FIGS. 1-8 illustrate an individual solar panel system 10 according to the invention.

The solar panel system 10 in this embodiment comprises a frame 55 on which 8 solar panels 30 are arranged. The frame 55 is supported on the ground by a support structure 50. Together the solar panels 30 form the solar cell assembly 30 of an individual solar panel system 10. Each solar panel 30 comprises a plurality of solar cells connected in series. The solar cell assemblies of an individual solar panel 30 here are divided into two parts that operate independently, so that a first part can be shaded while a second part in the sunlight still produces electricity. The solar panel here is thus a so-called half-cut solar panel. A longer side of the individual solar panel 30 here is about 2 metres long and a shorter side is about 1 metre long. The solar panels 30 are arranged on the frame 55 with the long sides facing each other and in the same plane in a horizontal orientation, so that a solar cell assembly 20 of the solar panel system 10 has a width W of approximately 8 metres and a height H of approximately 2 metres. The width of the solar cell assembly of the solar panel system is thus 4 times the height of the solar cell assembly. It is possible to use, for example, the commercial Znshinesolar 9BB HALF-CUT bifacial double-glass mono PERC panel of the ZXM6-NHLDD144 series as the solar panel 30. It is also possible to employ any other commercially available solar panel.

The frame 55 of the solar panel system 10 is an open structure made of metal tubes, so that the solar panels 30 are ventilated, which keeps a temperature of the solar panels 30 low and an efficiency thus high. The frame 55 is triangular when the solar panel system 10 is viewed from the side (FIG. 3, 6). The triangular shape shifts the centre of gravity to the point of articulation of the vertical tilt and reduces the work required to change the vertical tilt, thus saving power employed in an adjustment. The solar panels 30 are attached to a cross-frame element 56 of the frame 55, which cross-frame element 56 is connected at its centre to the support structure 50. At the point of articulation between the support structure 50 and the frame 55, a rotation means 60 and a tilting means 70 are provided, by means of which the solar cell assembly 20 attached to the frame 55 can be moved according to two axes relative to the support structure 50. The frame 55 can be rotated relative to an azimuthal direction of the sun by the rotation means 60 and tilted relative to an elevation of the sun by the tilting means 70. Both the rotation means 60 and the tilting means 70 comprise electric motors which provide the force required to move the frame 55 and the attached solar cell assembly 20.

At the point of articulation, the frame 55 includes a support element 80 (FIG. 1, 3) mechanically attached at a first end to the cross-frame element 56, the support element 80 projecting perpendicularly outwards from the cross-frame element 56 on the rear side of the solar panels 30. If the frame 55 is viewed from the side, lateral supports 57 extending between the ends of the cross-frame element 56 and a second end of the support element 80 form the triangular profile (FIG. 6).

FIG. 4 illustrates the section C from FIG. 3. The second end of the support element 80 includes support means 81 configured to be supported against the support structure 50 when the solar panels 20 are in a horizontal position. In FIGS. 3-6, the solar cell assemblies 20 are positioned in a horizontal plane, so that the solar panel system 10 is protected from a load caused by high winds. The solar panels 30 can thus be turned in high winds so as to be a fully horizontal, so that the lateral surface area of the solar panel system 10 is minimized and the support element 80 is also supported against the support structure 50, so that the solar panel system 10 remains firmly in place. In addition, in cases where the sun is shining high enough in the sky in strong winds, the solar panel system 10 is able to produce electricity without interruption. The support means 81 here comprise a notch configured to fit around the circular cross-section of the shaft of the support structure 50. The notch is thus in contact with the support structure 50 at an angle of 180°. By means of the rotation means 60, the notch can be positioned according to the direction of the wind so that the notch is on a rear side of the support structure viewed from the direction of the wind, so that the solar panel system 10 can be protected from a storm with any wind direction.

The support element 80 also shifts the centre of gravity of the frame 55 and the attached solar panels 30 closer to the point of articulation, which lessens the mechanical load of the rotation means 60 and of the tilting means 70, thus reducing the work performed to bring about movements and decreasing the power consumed in an adjustment.

The support structure 50 in this embodiment is a post placed in the ground, a height of which, i.e. the distance between the ground surface and the point of articulation, can be 1.7-3.0 m. This leaves a maintenance space underneath the solar cell assembly 20 and the frame 55 with room for a human being or, for example, sheep in order to keep vegetation short.

FIGS. 9 and 10 illustrate a plurality of solar panel systems 10 according to FIGS. 1-8 arranged so as to form a solar panel field 40. The solar panel systems 10 here are arranged in a basically rectangular grid formation, in which a distance D between centres of support structures 50 of individual solar panel systems 10 is identical between the solar panel systems 10 in adjacent rows and between adjacent solar panel systems 10 in the same row. Alternatively, for example, it is also possible to employ a so-called brick layout, in which the location of the support structures 50 in each row formed by the solar panel systems 10 differs by half the distance between the support structures 50 in successive rows in a south-north or east-west direction. Other layouts are also possible, and the final selection of a layout will depend, among other things, on the location and conditions of the solar panel field as well as the time of day during which a production is deemed more important. Preferably, adjacent solar panel systems 10 are placed as close together as possible in order to make efficient use of the land surface area. A minimum possible distance D is determined in relation to the dimensions of the solar cell assembly 20 so that the solar cell assemblies 20 do not collide with one another when rotating and when tilting. The distance D can be 1.05-1.3 times the width W of the solar cell assembly 20 of an individual solar panel system 10, taking into account an installation tolerance of the support structures 50. In order to save costs, a plurality of individual solar panel systems 10 in the solar panel field 40 are electrically connected in series to the same inverter. An electricity output thus depends on the functioning of each solar panel system 10 connected in series, so that it is important for the total output to ensure that each solar panel system 10 produces electricity for as much of the day as possible. For example, the combined active surface area of the solar panels 30 here is 1760 m² and the total land surface area used by the solar panel field 40 is 8100 m², giving the solar panel field 40 an effective density of 22%.

In this embodiment, each solar panel system 10 comprises its own rotation means 60 and tilting means 70. The movements of the solar panel systems 10 in the solar panel field 40 can be fully synchronized so that during production each solar cell assembly 20 is in the same position relative to the sun. The solar panel systems 10 can also be controlled independently during the day so that different sections of the solar panel field 40 are controlled according to different criteria. Preferably, the movements of the solar cell assemblies 20 are automated by software means.

In another embodiment, the solar panel systems 10 of the solar panel field 40 are mechanically connected to one another by connection means, such as cables or rods, so that a plurality of solar cell assemblies are rotated and/or tilted by a single unit. In other words, there can be one rotation means 60 and/or one tilting means 70 configured to rotate and tilt a plurality of solar cell assemblies 20, for example by row or all solar cell assemblies 20 of the solar panel field 40.

FIGS. 11a-11f depict, in a series of illustrations, movements of the solar panel field 40 according to the invention during the day. It is not an object of invention to track the movement of the sun by keeping the solar cell assemblies 20 perpendicular to the sun throughout the day, but to maximize a total output of a solar panel field 40 by taking into account an inter-shading of solar panel systems 10. This means that, in particular when the incoming angle of the sun's rays is very small, preferably less than 20°, the solar cell assemblies 20 can be rotated at a selected moment in time to a very steep angle of incidence, for example 45° relative to the direction of incoming sunlight. The invention has permitted the surprising observation that the output of modern solar panels 30 remains very high even at a steep angle of incidence.

The system generally comprises control means by means of which, at a selected moment in time, when the incoming angle of the sun's rays (K1) is greater than a selected minimum value, preferably greater than 1°, but less than a selected limit value, preferably less than 20°, more preferably less than 10°, most preferably less than 5°, the solar cell assemblies (20) are configured to be rotated by the rotation means (60) so that an angle of rotation (K4) of the solar cell assemblies (20) relative to the direction of incoming sunlight is 20°-50°, preferably 30°-45°, and to be tilted by the tilting means (70) in order to reduce a three-dimensional solar incidence angle of the solar cell assemblies (20) in such a manner that the solar cell assemblies (20) do not overshadow one another, by means of which rotation and tilting of the solar cell assemblies (20) an inter-shading that would otherwise occur is prevented and an electricity output is maximized.

Shading arises in the direction of the incoming sunlight when the upper part of a front solar panel system 10 overshadows the lower part of a solar cell assembly 20 of a rear solar panel system 10. This can be partially compensated by using half-cut solar panels, whereby the upper part and lower part of the solar cell assembly 20 are separated into independently operating units.

Shading can also arise at the ends of the solar cell assemblies 20. If the motion of the sun is tracked according to the prior art by keeping the solar cell assemblies 20 perpendicular to the sun, or the solar panel systems 10 are rotated without taking shading into account, an edge of a front solar cell assembly 20 in the direction of incoming sunlight can overshadow an edge of a rear solar cell assembly 20 at certain times. In the event that the surface area of an end shading is too large, even when half-cut solar panels are employed, the shading will cause the output of the entire solar panel system and of the entire solar panel field to collapse. This occurs in particular at low incoming angles of sunlight.

In the method according to the invention, a total diurnal output of the field is maximized by preventing a shading throughout the day, so that the solar panel field 40 is advantageously producing electricity without interruption when the sun is above the horizon. In order to achieve this, instead of keeping an individual solar panel system 10 constantly at an optimum angle relative to the sun in order to maximize an output of the individual solar panel system 10, the electricity production of the entire solar panel field 40 is maximized by minimizing shading throughout the day.

Preferably, the solar panel field 40 is built on flat land, as is the case in the embodiments illustrated here. It is also possible for a solar panel field 40 to be built, for example, on a south-facing slope or for contours of a ground surface to be compensated by a height of the support structures 50.

FIG. 12 illustrates a positioning of the solar cell assemblies 20 of the solar panel systems 10 in a situation in which the incoming angle of the sun's rays is 19.73°, which corresponds, for example, to a sunny day in late February in Helsinki when the sun is at its zenith or to a sunny morning/evening in midsummer. The solar cell assemblies 20 here are first rotated by the rotation means 60 so as to be perpendicular to the azimuthal direction of the sun. Next, the inclination of the solar cell assemblies 20 is set by the tilting means 70 so that a front solar panel system 10 in the direction of the incoming sunlight does not overshadow a solar cell assembly 20 of a rear solar panel system 10 while the solar cell assembly 20 still lies as perpendicular to the sun as possible. The solar cell assemblies 20 here are consequently not perfectly perpendicular to the sun, as otherwise a front solar panel system 10 in the direction of the incoming sunlight would overshadow a solar cell assembly 20 of a rear solar panel system 10, whereby the output of the rear solar panel system would collapse to zero and the concurrent output of the entire solar panel field 40 would be negligible. The solar cell assemblies 20 are consequently rotated and tilted significantly so as to deviate from the optimum—in terms of the output of the individual solar cell assembly-orthogonal angle, whereby an output of the entire solar panel field 40 can be maximized at the time in question.

FIG. 13 illustrates the principle for adjusting the inclination of a solar cell assembly 20 by the tilting means 70. In this example, the incoming angle of the sun's rays is a very low 4°. When the individual solar panel system is at the optimal—i.e. as orthogonal as possible-angle of inclination for the output of the individual solar panel system, the solar cell assemblies 20.1 overshadow one another to a very large extent. A sunbeam A that passes over a front solar cell assembly 20.1 will thus hit the upper part of a rear solar cell assembly 20.1, so that the electricity output of even a half-cut solar panel will be zero. Solar cell assemblies 20.3 placed at a very steep angle do not overshadow one another, but the angle of incidence of the sunbeams A on the surface of the solar panels 30 in this case is very large, so that an efficiency of electricity production remains low. A solar cell assembly 20.2 tilted between these two extremes only overshadows the lower part of the rear solar cell assembly 20 consisting of half-cut solar panels, so that the upper part produces electricity efficiently when the angle of incidence is relatively small. The optimal setting between an entirely unshaded solar cell assembly 20.1 and an orientation of a solar cell assembly 20.2 implemented for half-cut panels depends, among other things, on the IAM curve of the solar panels, i.e. on a loss as the angle of incidence increases.

FIGS. 14-17 illustrate the principle for rotating the solar cell assembly 20 by the rotation means 60. In this example, the height H of the solar cell assemblies 20 is about 2 m and the distance D between the solar panel systems 10 in the direction of the incoming sunbeams A is about 11.8 m.

In FIGS. 14 and 16, the solar cell assemblies 20 are rotated so as to form straight rows and the incoming sunbeams A are perpendicular to the solar cell assemblies 20, i.e. the angle of rotation K4 of the solar cell assemblies 20 is 90°. As illustrated in FIG. 14, the lowest incoming angle K1 of the sunbeams A at which each solar cell assembly 20 remains entirely in sunshine, without shading, is 3.13°. Accordingly, the lowest incoming angle K2 of the sunbeams A at which it is possible to produce electricity with half-cut solar panels, i.e. at which the upper part of a rear solar cell assembly 20 is entirely in sunshine, is 1.42°. In this example, the angle of inclination K3 of the solar cell assemblies 20 is 75°.

In FIGS. 15 and 17, the angle of rotation K4 of the solar cell assemblies 20 is 45°, while the angle of inclination K3 is again 75°, as in FIGS. 14 and 16. The effective distance D′ between successive solar cell assemblies 20 can thus be increased by rotating the solar cell assemblies 20 so as to form a straight row, so that the incoming angle of the sun's rays is 45°. In other words, the sun shines in this example from a lateral angle of 45°, i.e. the solar cell assemblies 20 are pointed in a lateral direction of rotation 45° in relation to the sun. In this example, the effective distance D′ between successive solar cell assemblies 20 thus increases to about 16.7 metres, i.e. D′=1.41*D. As illustrated in FIG. 15, the lowest incoming angle K1 of the sunbeams A at which each solar cell assembly 20 remains entirely in sunshine, without shading, is 2.1°. Accordingly, the lowest incoming angle K2 of the sunbeams A at which it is possible to produce electricity with half-cut solar panels, i.e. at which the upper part of a rear solar cell assembly 20 is entirely in sunshine, is 0.98°. Thus, by setting the angle of rotation K4 so that it deviates significantly from the conventionally orthogonal angle, it becomes possible to produce electricity at a lower incoming angle of the sun's rays than to date. The angle of incidence of the sunbeams A in relation to the solar cell assembly 20 is kept within a range, however, in which an output coefficient (IAM) resulting from the incoming angle of the sun's rays remains above 0.9, preferably above 0.95.

In other words, with the method according to the invention, in which a solar incidence angle of the solar cell assemblies 20 is rotated so as to deviate very significantly from the perpendicular, it is possible at a low incoming angle of the sun's rays to reach a state in which the system according to the invention produces electricity, while in an analogous situation the output of a stationary solar panel field or of sun-tracking solar panels according to the prior art would be zero (or a very low output produced by scattered light) due to an inter-shading of the solar panels.

In order to eliminate an inter-shading, the solar cell assemblies 20 can first be rotated to an advantageous angle of rotation K4 and then tilted to an angle of inclination K3 as perpendicular as possible to the sun in such a manner that the solar cell assemblies 20 do not overshadow one another. By rotating the solar panels to an angle of rotation K4 of, for example, 45° relative to the sun, the angle of inclination K3 of the solar cell assemblies 20 can be increased vis-à-vis an angle of rotation K4 that is completely perpendicular to the sun. The output of the solar panels in this case remains high when the total angle of incidence is small, although the angle of rotation K4 relating to the azimuthal direction is set to be surprisingly high.

In contrast to the sun-tracking solar panel fields according to the prior art, the position of the solar panel systems 10 is only changed a few times a day in the method according to the invention. An electric motor of the rotation means 60 and tilting means 70 is subjected to stresses when started up, so that the service life of the electric motors is significantly lengthened. The position of the solar cell assemblies 20 is changed 2-7 times, preferably 3-6 times, diurnally by rotating the solar cell assemblies 20 with the rotation means 60 and simultaneously tilting the solar cell assemblies with the tilting means 70. Preferably, the rotation means 60 and the tilting means 70 are only used every 2-3 hours or so, so that an individual solar cell assembly 20 is rotated by 20°-30° at a time. This extends the service life of the electric motors of the rotation means 60 and tilting means 70, while the efficiency of electricity production remains high since the output coefficient resulting from the angle of incidence is still constantly kept at a high level. Rotating the front orientation of a large solar field 40 also consumes a considerable amount of power. Consequently, electricity is also saved compared to solar panels that track the sun in a perpendicular manner or solar panels that must be rotated numerous times diurnally, which increases the total electricity output of the solar panel field 40.

1. A system for producing electricity with solar panels north of the latitude 55°N or south of the latitude 55° S, which system comprises a plurality of individual solar panel systems arranged in a grid formation so as to form a solar panel field, wherein each individual solar panel system comprises a solar cell assembly made up of solar panels that is configured to be movable on a support structure with respect to two axes, so that a connection of each individual solar cell assembly to the support structure comprises rotation means for rotating the solar cell assembly relative to a vertical axis of the support structure and tilting means for tilting the solar cell assembly relative to a horizontal plane, and wherein, when an incoming angle of the sun's rays in the grid formation is less than 20° and when the solar cell assemblies are perpendicular to the sun, the solar cell assemblies overshadow one another, wherein in the system a width of the solar cell assembly of each solar panel system is 3-6 times, preferably 3.5-5 times, a height of the solar cell assembly, wherein
the system comprises control means by means of which, at a selected moment in time, when an incoming angle of the sun's rays is greater than a selected minimum value, preferably greater than 1°, but less than a selected limit value, preferably less than 20°, more preferably less than 10°, most preferably less than 5°, the solar cell assemblies are configured to be rotated by the rotation means so that an angle of rotation of the solar cell assemblies relative to the direction of incoming sunlight is 20°-50°, preferably 30°-45°, and
tilted by the tilting means in order to reduce a three-dimensional solar incidence angle of the solar cell assemblies in such a manner that the solar cell assemblies do not overshadow one another,
by means of which rotation and tilting of the solar cell assemblies an inter-shading that would otherwise occur is prevented and an electricity output is maximized.

2. The system according to claim 1, wherein in a distance between the support structures of the solar panel systems in the grid formation is 1.05-1.3 times the width of the solar cell assembly of an individual solar panel system.

3. The system according to claim 1, wherein a combined surface area of all solar panels in the solar panel field is 10-40%, preferably 15-35%, most preferably 20-30%, of the total land surface area of the solar panel field.

4. The system according to claim 1, wherein the tilting means is configured to tilt the solar cell assembly in a first end position into an essentially vertical position and in a second end position into an essentially horizontal position.

5. The system according to claim 1, wherein a frame of each solar panel system comprises, at a point of articulation, an outwardly projecting support element on the rear side of the solar cell assembly, wherein a first end of the support element is attached to the solar cell assembly and a second end of the support element comprises support means configured to be supported against the support structure when the solar cell assembly is in a horizontal position.

6. The system according to claim 1, wherein a height of the support structure is 1.7-3.0 m, so that a maintenance space is provided under each solar cell assembly.

7. The system according to claim 1, wherein the solar cell assembly of each solar panel system is provided in the form of two or more parts that operate independently, wherein a first part is located in an upper part of the solar cell assembly and a second part or the following parts are located underneath the first part in a lower part of the solar cell assembly.

8. The system according to claim 1, wherein the height of the solar cell assembly of each solar panel system is 1.3-3 m, advantageously 1.8-2.5 m.

9. The system according to claim 1, wherein the width of the solar cell assembly of each solar panel system is 5-10 m, preferably 7-9 m.

10. A method for producing electricity with solar panels north of the latitude 55°N or south of the latitude 55°S, in which method a plurality of solar panel systems are placed in a grid formation so as to form a solar panel field, wherein each individual solar panel system comprises a solar cell assembly made up solar panels arranged on a support structure, with respect to which support structure the solar cell assembly is moved during the day with respect to two axes in such a manner that the solar cell assembly is rotated relative to a vertical axis of the support structure and tilted relative to a horizontal plane, and wherein, when an incoming angle of the sun's rays in the grid formation is less than 20° and when the solar cell assemblies are perpendicular to the sun, the solar cell assemblies overshadow one another, and in which method a width of the solar cell assembly of each solar panel system is 3-6 times, preferably 3.5-5 times, a height of the solar cell assembly, wherein,
at a selected moment in time, when an incoming angle of the sun's rays is greater than a selected minimum value, preferably greater than 1°, but less than a selected limit value, preferably less than 20°, more preferably less than 10°, most preferably less than 5°,
the solar cell assemblies are rotated so that an angle of rotation of the solar cell assemblies relative to the direction of incoming sunlight is 20°-50°, preferably 30°-45°, and
the solar cell assemblies are tilted in order to reduce a three-dimensional solar incidence angle of the solar cell assemblies in such a manner that the solar cell assemblies do not overshadow one another,
by means of which rotation and tilting of the solar cell assemblies an inter-shading that would otherwise occur is prevented and an electricity output is maximized.

11. The method according to claim 10, wherein the three-dimensional solar incidence angle of the solar cell assemblies is minimized with an accuracy of +/−5%, preferably +/−2%.

12. The method according to claim 10, wherein the solar panel systems are placed in the grid formation in such a manner that a distance between the support structures is 1.05-1.3 times the width of the solar cell assembly of an individual solar panel system.

13. The method according to claim 10, wherein the solar panel systems are placed in a dense grid in such a manner that a combined surface area of all solar panels of the solar panel field is 10-40%, preferably 15-35%, more preferably 20-30%, of the total land surface area of the solar panel field.

14. The method according to claim 10, wherein the solar cell assembly of each solar panel system is provided in the form of two or more independently operating parts, a first part being arranged in an upper part of the solar cell assembly and a second part or the following parts being arranged underneath the first part in a lower part of the solar cell assembly, and at a selected point in time the solar cell assemblies are tilted so as to be as perpendicular as possible to the sun so that the first part or the uppermost parts of each solar cell assembly are in the sun and the second part or the lowermost parts are allowed to be shaded if necessary.

15. The method according to claim 10, wherein the position of the solar cell assemblies is changed 2-7 times, preferably 3-6 times, diurnally.

16. The method according to claim 10, wherein, at a selected instant of time, when the incoming angle of the sun's rays is greater than 20°, the solar cell assemblies are oriented so as to be perpendicular to the sun.
